(19) United States
(12) Patent Application Publication
(10) Pub. No.: US 2009/0201278 A1
(43) Pub. Date: Aug. 13, 2009

(54) Unit pixels and active matrix organic light emitting diode displays including the same

(75) Inventor: Michael G. Kane, Princeton, NJ (US)

Correspondence Address: HARNESS, DICKEY & PIERCE, P.L.C., P.O. BOX 8910, RESTON, VA, 20195, US

(73) Assignee: Samsung Electronics Co., LTD.

(21) Appl. No.: 12/289,438

(22) Filed: Oct. 28, 2008

Related U.S. Application Data
(63) Continuation-in-part of application No. 12/068,893, filed on Feb. 13, 2008.
Application No. 12/068,893 is a continuation-in-part of application No. 12/068,894, filed on Feb. 13, 2008.

(51) Int. Cl. G06F 3/038

(52) U.S. Cl. 345/211

(57) ABSTRACT

A unit pixel of an organic light emitting diode (AMOLED) display includes an organic light emitting diode, a driving transistor, a programming transistor, a switching transistor, and a memory capacitor. An active matrix organic light emitting diode (AMOLED) display includes a plurality of the unit pixels. The unit pixels and AMOLED displays are more easily manufactured in a simpler structure and capable of displaying higher quality images by effectively suppressing changes in pixel brightness according to a threshold voltage shift of a driving transistor.

### CROSS-REFERENCE TO RELATED APPLICATIONS

This application is a continuation-in-part of, and claims priority under 35 U.S.C. §120 to U.S. patent application Ser. No. 12/068,894, filed on Feb. 13, 2008, and U.S. patent application Ser. No. 12/068,893, filed on Feb. 13, 2008. The entire contents of each of these applications are incorporated herein by reference.

### BACKGROUND

1. Description of the Related Art

Conventional active matrix organic light emitting diode (AMOLED) displays have faster response characteristics and wider viewing angles than liquid crystal displays (LCDs). Conventional AMOLED displays include a plurality of pixels. Each pixel includes a switching transistor (sampling transistor), which samples an analog image signal; a memory capacitor, which stores an image signal in the pixel; and a driving transistor, which controls a current supplied to an OLED according to a voltage of the image signal stored in the memory capacitor.

In more detail, the switching transistor is a switching device that allows a data voltage to be applied to the driving transistor, and thus, should have a relatively low leakage current and a relatively fast response characteristic. The driving transistor supplies a current to the OLED and should have relatively reliable current supply for a relatively long time. Typically, channels of the switching and driving transistors are formed of amorphous silicon or polycrystalline silicon.

Polycrystalline silicon has higher mobility and degrades more slowly during operational life than amorphous silicon. Thus, polycrystalline silicon is generally preferred over amorphous silicon. However, polycrystalline silicon has a disadvantage in terms of an occurrence of a relatively high off-current due to a leakage current through grain boundaries. Also, polycrystalline silicon has relatively low uniformity, and thus, is relatively difficult to uniformly operate in each pixel.

Self-compensating voltage programmed AMOLED pixels, self-compensating current programmed AMOLED pixels, and other compensation methods, have been suggested to compensate for such a uniformity disadvantage. However, in utilizing these compensation schemes circuits become complicated due to compensation devices. As a result, a design for manufacturing conventional AMOLED displays is relatively complicated.

### SUMMARY

Example embodiments relate to unit pixels and active matrix organic light emitting diode (AMOLED) displays, for example, current programmable AMOLED displays and pixels thereof, which may be more easily manufactured and/or have a simpler structure.

Example embodiments provide unit pixels and active matrix organic light emitting diode (AMOLED) displays and pixels thereof capable of displaying a higher quality image by effectively suppressing and/or preventing changes in pixel brightness according to a threshold voltage shift of a driving transistor.

Example embodiments also provide AMOLED displays and pixels thereof capable of displaying increased yield and/or simplifying the structure of a unit pixel by adopting a smaller number of transistors. Example embodiments also provide AMOLED displays capable of displaying higher quality images using amorphous silicon.

At least one example embodiment provides a unit pixel of an organic light emitting diode (AMOLED) display. The unit pixel may include an organic light emitting diode, a memory capacitor, a driving transistor, a programming transistor and a switching transistor. The driving transistor may include a first terminal connected to the organic light emitting diode, and a second terminal supplied with a driving voltage for the operation of the organic light emitting diode. The memory capacitor may be connected in parallel between a gate of the driving transistor and one of the first and second terminals of the driving transistor. The programming transistor may include a gate configured to receive scan signals, a first terminal configured to receive data current signals, and a second terminal connected to the first terminal of the driving transistor. The switching transistor may include a first terminal connected to the gate of the driving transistor, a gate connected to the gate of the programming transistor, and a second terminal connected to one of a direct current (DC) bias voltage and the second terminal of the programming transistor.

At least one other example embodiment provides an AMOLED display including a plurality of scan lines and a plurality of data lines arranged in a matrix. The plurality of scan and data lines define a plurality of pixel areas. A unit pixel may be provided in each of the pixel areas. The unit pixel may include an organic light emitting diode, a memory capacitor, a driving transistor, a programming transistor and a switching transistor. The driving transistor may include a first terminal connected to the organic light emitting diode, and a second terminal supplied with a driving voltage for the operation of the organic light emitting diode. The memory capacitor may be connected in parallel between a gate of the driving transistor and one of the first and second terminals of the driving transistor. The programming transistor may include a gate configured to receive scan signals, a first terminal configured to receive data current signals, and a second terminal connected to the first terminal of the driving transistor. The switching transistor may include a first terminal connected to the gate of the driving transistor, a gate connected to the gate of the programming transistor, and a second terminal connected to one of a direct current (DC) bias voltage and the second terminal of the programming transistor. The AMOLED display may further include a current controller configured to determine a current flowing through the driving transistor and the programming transistor in each of the unit pixels.

At least one other example embodiment provides an AMOLED display. According to at least this example embodiment, a driving transistor may include a source connected to an organic light emitting diode. A drain of the driving transistor may be supplied with a driving voltage for operating the organic light emitting diode. A memory capacitor may be connected to a gate and the source of the driving transistor in parallel. A programming transistor may include a gate supplied with scan signals and a source supplied with data current signals. A drain of the programming transistor may include a drain connected to the source of the driving transistor. A switching transistor may include a source connected to the gate of the driving transistor, a gate connected to a scan line, and a drain supplied with a direct current (DC) bias voltage. A current controller may determine a current flowing through the driving and programming transistors.

At least one other example embodiment provides an AMOLED display. According to at least this example embodiment, a plurality of scan lines and a plurality of data lines may be arranged on an X-Y matrix. An organic light emitting diode may be provided in each of pixel areas defined by the scan lines and the data lines. A driver may drive the organic light emitting diode in each of the pixel areas. The driver may include a driving transistor including a source connected to the organic light emitting diode. A drain of the driving transistor may be supplied with a driving voltage for operating the organic light emitting diode. A memory capacitor may be connected to a gate and the source of the driving transistor in parallel. A programming transistor may include a gate supplied with scan signals and a source supplied with data current signals. A drain of the programming transistor may include a drain connected to the source of the driving transistor. A switching transistor may include a source connected to the gate of the driving transistor, a gate connected to a scan line, and a drain supplied with a direct current (DC) bias voltage. A current controller may determine a current flowing through the driving and programming transistors.

According to at least some example embodiments, the driving, switching, and programming transistors may be N-channel transistors. The bias voltage may be a positive voltage less than the driving voltage.

Example embodiments also provide active matrix organic light emitting diode (AMOLED) displays capable of displaying a relatively high quality image by effectively suppressing and/or preventing changes in pixel brightness according to a threshold voltage shift of a driving transistor. Example embodiments also provide AMOLED displays capable of increasing yield and/or simplifying the structure of a unit pixel by adopting a smaller number of transistors.

At least one example embodiment provides an organic light emitting diode (AMOLED) display. According to at least this example embodiment, a driving transistor may include a drain connected to the organic light emitting diode and a source supplied with a driving voltage for operating the organic light emitting diode. A memory capacitor may be connected to a gate and the source of the driving transistor in parallel. A programming transistor may include a gate and a drain supplied with scan and data signals, respectively, and a source connected to the drain of the driving transistor. A switching transistor may include a gate and a drain connected to the gate and the source, respectively, of the programming transistor. A source of the switching transistor may be connected to the gate of the driving transistor. A current controller may determine a current flowing through the driving and programming transistors.

At least one other example embodiment provides an AMOLED display. According to at least this example embodiment, a plurality of scan lines and a plurality of data lines may be disposed in an X-Y matrix. An organic light emitting diode may be provided in each of pixel areas defined by the scan lines and the data lines. A driver may drive the organic light emitting diode in each of the pixel areas. The driver may include a driving transistor. The driving transistor may include a drain connected to the organic light emitting diode and a source supplied with a driving voltage for operating the organic light emitting diode. A memory capacitor may be connected to a gate and the source of the driving transistor in parallel. A programming transistor may include a gate and a drain connected to the scan and data lines, respectively, and a source connected to the drain of the driving transistor. A switching transistor may include a gate and a drain connected to the gate and the source, respectively, of the programming transistor. A source of the switching transistor may be connected to the gate of the driving transistor. A current controller may determine a current flowing through the driving and programming transistors. The driving, switching, and programming transistors may be p-channel transistors.

### BRIEF DESCRIPTION OF THE DRAWINGS

The present invention will become more apparent by describing in detail example embodiments thereof with reference to the attached drawings in which:

FIG. 1 is a schematic equivalent circuit diagram of an active matrix organic light emitting diode (AMOLED) display according to an example embodiment;

FIG. 2 is an equivalent circuit diagram of a unit pixel of the AMOLED display of FIG. 1;

FIGS. 3A and 3B are equivalent circuit diagrams of the unit pixel for illustrating the operation of the AMOLED display of FIG. 1; and

FIGS. 4 and 5 are graphs illustrating results of simulations performed on the performance of the AMOLED display of FIG. 1.

FIG. 6 is a schematic equivalent circuit diagram of an active matrix organic light emitting diode (AMOLED) display according to an example embodiment;

FIG. 7 is an equivalent circuit diagram of a unit pixel of the AMOLED display of FIG. 6;

FIGS. 8A and 8B are equivalent circuit diagrams of the unit pixel for illustrating the operation of the AMOLED display of FIG. 6; and

FIGS. 9 and 10 are graphs illustrating results of simulations performed on the performance of the AMOLED display of FIG. 6.

### DETAILED DESCRIPTION OF EXAMPLE EMBODIMENTS

Various example embodiments of the present invention will now be described more fully with reference to the accompanying drawings in which some example embodiments of the invention are shown. In the drawings, the thicknesses of layers and regions are exaggerated for clarity.

Detailed illustrative embodiments of the present invention are disclosed herein. However, specific structural and functional details disclosed herein are merely representative for purposes of describing example embodiments of the present invention. This invention may, however, may be embodied in many alternate forms and should not be construed as limited to only the embodiments set forth herein.

Accordingly, while example embodiments of the invention are capable of various modifications and alternative forms, embodiments thereof are shown by way of example in the drawings and will herein be described in detail. It should be understood, however, that there is no intent to limit example embodiments of the invention to the particular forms disclosed, but on the contrary, example embodiments of the invention are to cover all modifications, equivalents, and alternatives falling within the scope of the invention. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments of the present invention. As used herein, the term “and/or,” includes any and all combinations of one or more of the associated listed items.

It will be understood that when an element is referred to as being “connected,” or “coupled,” to another element, it can be directly connected or coupled to the other element or intervening elements may be present. In contrast, when an element is referred to as being “directly connected,” or “directly coupled,” to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting of example embodiments of the invention. As used herein, the singular forms “a,” “an,” and “the,” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Active matrix organic light emitting diode (AMOLED) displays according to example embodiments will now be described in more detail with reference to the attached drawings.

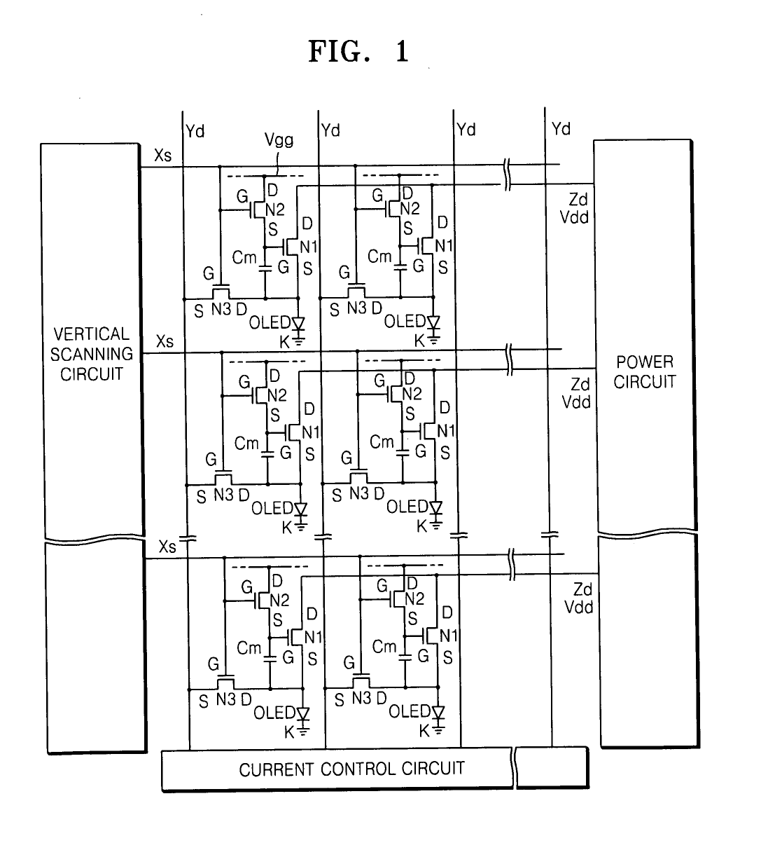

FIG. 1 is a schematic equivalent circuit diagram of an AMOLED display according to an example embodiment.

Referring to FIG. 1, a plurality of scan lines Xs may be arranged orthogonal to a plurality of data lines Yd to form a matrix structure. Power lines Zd may be arranged in parallel with the scan lines Xs at given, desired or predetermined distances from the scan lines Xs. Pixels may be positioned around or near intersections between the scan lines Xs and the data lines Yd. The scan lines Xs may be connected to a vertical scanning circuit, and the data lines Yd may be connected to a current controller circuit. The vertical scanning circuit may apply vertical scan signals (or vertical scan signals) to the scan lines Xs, and the current controller circuit may apply data current signals to the data lines Yd. A power circuit powers the AMOLED display via the power lines Zd.

Each pixel may include a plurality of (e.g., three) N-channel transistors N1, N2, and N3, and a memory capacitor Cm. The transistors N1, N2, and N3 may be amorphous silicon transistors, polycrystalline silicon transistors, or the like. In each pixel, a gate of the programming transistor N3 may be connected to the scan line Xs. A first terminal (source S) of the programming transistor N3 may be connected to the data line Yd. A second terminal (drain D) of the programming transistor N3 may be connected to a first terminal (source S) of the driving transistor N1.

The memory capacitor Cm may be connected in parallel between a gate and the first terminal (source S) of the driving transistor N1. For example, a first terminal of the memory capacitor Cm may be connected to a gate of the driving transistor N1 and a second terminal of the memory capacitor Cm may be connected to the first terminal (source S) of the driving transistor N1. The memory capacitor Cm may store image data for the pixel.

A second terminal (drain D) of the driving transistor N1 may be connected to a power line Zd. The driving transistor N1 may be supplied with a driving voltage Vdd via the power line Zd and the second terminal (drain D). An anode of an OLED may be connected to the first terminal (source S) of the driving transistor N1. A cathode K of the OLED may correspond to a common electrode (not shown) shared by the entire display.

A gate of the switching transistor N2 may be connected to the scan line Xs and to the gate of the programming transistor N3. A second terminal (drain D) of the switching transistor N2 may be connected to a bias line to which a bias voltage Vgg is supplied. The second terminal (drain D) of the programming transistor N3 may be connected to the first terminal (source S) of the driving transistor N1. The bias voltage Vgg may be a positive voltage, which is less than the driving voltage Vdd.

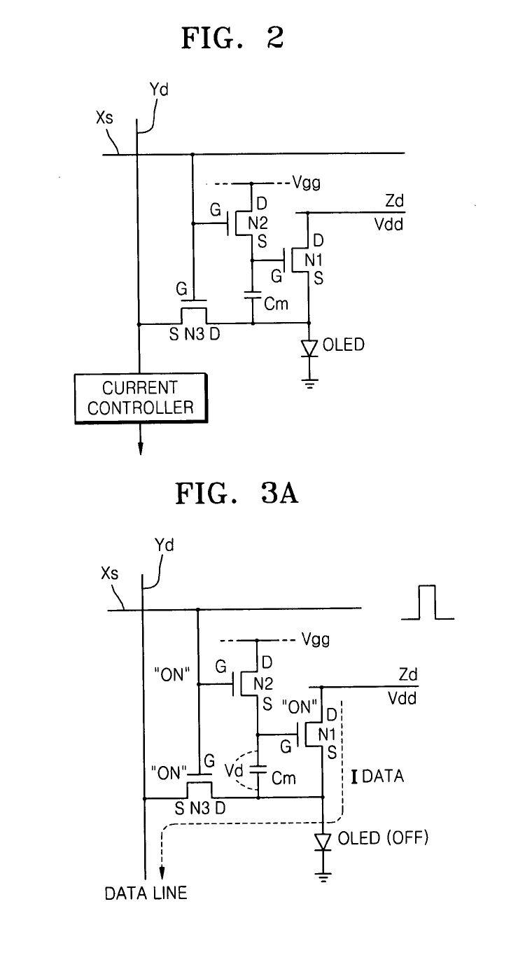

FIG. 2 is an equivalent circuit diagram of an example embodiment of a unit pixel of the AMOLED display of FIG. 1.

Referring to FIG. 2, a gate of the programming transistor N3 may be connected to the scan line Xs. The vertical scan signal may be input to the gate of the programming transistor N3 via the scan line Xs. The first terminal (source S) of the programming transistor N3 may be connected to the data line Yd. The data current signal may be applied to the first terminal (source S) of the programming transistor N3 via the data line Yd.

A gate of the switching transistor N2 may be connected to the scan line Xs and to the gate of the programming transistor N3. The gate of the switching transistor N2 may also be connected to the scan line Xs. The first terminal (source S) of the switching transistor N2 may be connected to the gate of the driving transistor N1. A direct current (DC) bias voltage necessary for the operation of the driving transistor N1 may be applied to the second terminal (drain D) of the switching transistor N2. A driving voltage Vdd may be applied to the second terminal (drain D) of the driving transistor N1 via the power line Zd. The first terminal (source S) of the driving transistor N1 may be connected to an anode of the OLED. A first terminal of the memory capacitor Cm may be connected to the gate of the driving transistor N1, and a second terminal of the memory capacitor Cm may be connected to the first terminal (source S) of the driving transistor N1.

A current controller (e.g., a current driving integrated circuit (IC)) as described above may be connected to the data line Yd. The current controller may determine a current flowing through the driving transistor N1 irrespective (or independent) of the threshold voltage of the driving transistor N1 to store a voltage corresponding to the current in the memory capacitor Cm. Accordingly, a given, desired or preset current may be applied to the OLED, and thus the current programmed AMOLED display may be capable of displaying higher quality images even using an amorphous silicon thin film transistor as an active element.

Example operation of the pixel of FIG. 2 will now be described.

According to at least one example embodiment, a pixel circuit of the AMOLED display may a current programmed type pixel circuit having a 3 transistor-1 capacitor (3T-1C) structure including the three N-channel transistors N1, N2, and N3 and the memory capacitor Cm.

The amount of a current flowing in the OLED may be controlled by the driving transistor N1. The amount of a current flowing in the driving transistor N1 may be controlled by a voltage formed at a gate node of the driving transistor N1. A voltage corresponding to a current flowing between the first terminal (source S) and the second terminal (drain D) of the driving transistor N1 may be stored and maintained in the memory capacitor Cm for a frame. A voltage at each terminal of the memory capacitor Cm may be automatically generated by a current flowing through the driving transistor N1. In this example, the programming and switching transistors N3 and N2 may turn on in response to a positive voltage scan signal.

Once the programming transistor N3 is turned on, a data current Idata flows through the programming transistor N3 connected to the data line Yd and the driving transistor N1 to which a positive driving voltage is applied from the power line Zd. The data current Idata applied by the current controller may be determined so as to correspond to a current, which is to flow in the OLED after the programming transistor N3 is turned off. Accordingly, if a given, desired or predetermined current flows through the driving transistor N1, a voltage corresponding to the current may be automatically induced at each terminal of the memory capacitor Cm. Accordingly, a constant or substantially constant current may flow in the OLED regardless of a characteristic difference caused by the position and the process of a thin film transistor array. Thus, more uniform brightness may be achieved.

The above-described processes will now be described in phases with reference to FIGS. 3A and 3B.

Initially, the programming and switching transistors N3 and N2 may be turned off and the driving transistor N1 may provide a current to the OLED from a previous frame.

A current programming step may be performed by applying a positive scan signal for selecting a specific pixel through the scan line and the data line so as to turn on the programming transistor N3 and the switching transistor N2 (as shown in FIG. 3A). Once the switching transistor N2 is turned on, a voltage at the gate node of the driving transistor N1 may decrease to the level of a bias voltage Vgg, and thus, the current may stop flowing through the OLED. Accordingly, a programming current Idata flows through the programming transistor N3 and the driving transistor N1. The amount of the programming current Idata may be determined by the current controller as described above. As a result, a voltage Vd corresponding to the current may be induced at the gate and the first terminal (source S) of the driving transistor N1, that is at each terminal of the memory capacitor Cm as shown in FIG. 3A.

Referring to FIG. 3B, the corresponding signal applied through the scan line Xs may be suppressed and/or blocked to turn off the programming transistor N3 and the switching transistor N2. In this example, a current supplied to the OLED may be controlled according to the voltage stored in the memory capacitor Cm. This voltage may be induced so as to correspond to a current necessary for the OLED in a programming process. As a result, a desired amount of current may be supplied to the OLED as shown in FIG. 3B.

If a method as described above is used, differences between threshold voltages of the driving transistors may be overcome. Also, more uniform programming currents Idata may be supplied to the OLEDs of all or substantially all pixels. Thus, pixels showing more uniform brightness on the entire display may be realized.

FIGS. 4 and 5 are graphs illustrating results of simulations performed on the performance of an example embodiment of a unit pixel of the AMOLED display of FIG. 1. The transistor parameters for N1, N2, and N3 are based on typical parameters for amorphous silicon-based field-effect transistors (FETs), and the OLED parameters are based on typical OLED devices. FIG. 4 illustrates an example relationship between a data voltage and an OLED current. FIG. 5 illustrates an example relationship between a data current and the OLED current.

In FIGS. 4 and 5, “A” indicates a threshold voltage which has not shifted, “B” indicates a threshold voltage which has been shifted by +1 V, and “C” indicates a threshold voltage which has been shifted by +5 V.

According to the results of the simulations, an error of about 98% occurs in the shift of the threshold voltage of +5 V in the conventional method, whereas an error of only about 21% occurs in example embodiments.

Example embodiments may be applied to display devices, such as, AMOLED displays using OLEDs. The AMOLED displays may use amorphous silicon transistors as active elements.

As described above, in AMOLED displays according to example embodiments, a current programming method may supply a more uniform current to OLEDs of all or substantially all pixels regardless of a difference between the threshold voltages of driving transistors. Thus, an image having more uniform brightness may be realized. According to the experimental results, a current may be controlled more precisely with respect to a shift of a threshold voltage Vth of a driving transistor than in conventional methods. Such a current programmed display according to example embodiments may have a simpler structure than conventional current programmed self-compensating pixel circuits. A desired current necessary for the OLEDs may be supplied to the OLEDs regardless of the degradation of the transistors and a performance difference between the pixels. Thus, example embodiments may adopt n-channel transistors such as amorphous silicon transistors as well as organic thin film transistors or polycrystalline silicon transistor.

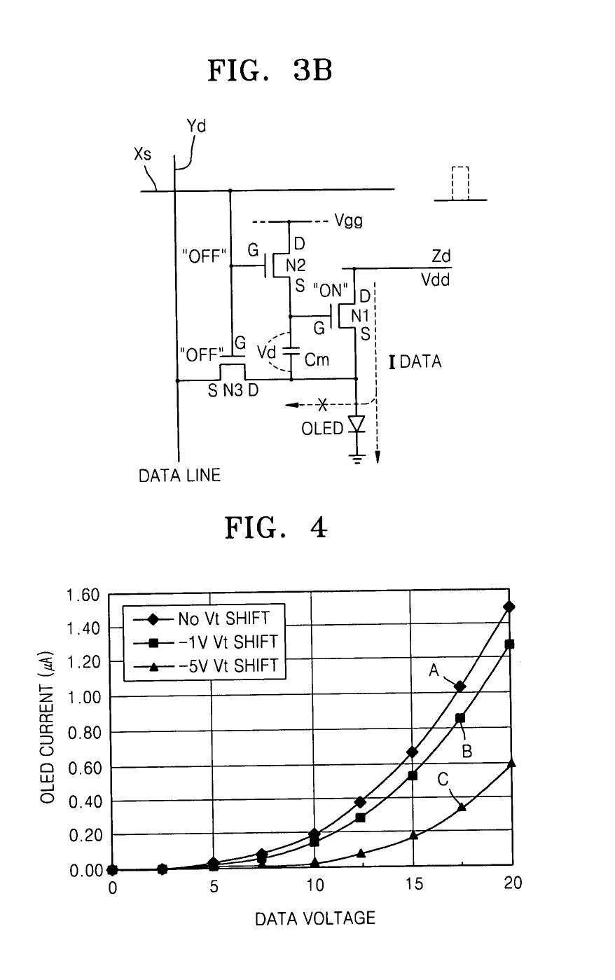

FIG. 6 is a schematic equivalent circuit diagram of an AMOLED display according to another example embodiment.

Referring to FIG. 6, a plurality of scan lines Xs may be arranged orthogonal to a plurality of data lines Yd to form a matrix structure. Power lines Zd may be arranged in parallel with the scan lines Xs at given, desired or predetermined distances from the scan lines Xs. Pixels may be positioned around, near or at intersections between the scan lines Xs and the data lines Yd. Vertical scan signals (vertical scan signals) may be applied to the scan lines Xs. Data current signals may be applied to the data lines Yd. The scan lines Xs may be connected to a vertical scanning circuit, whereas the data lines Yd may be connected to a current controller circuit. The power lines Zd may be connected to a power circuit for powering the AMOLED display.

Each unit pixel may include a plurality of (e.g., three) p-channel transistors P1, P2, and P3 and a memory capacitor Cm. In each pixel, a gate of the programming transistor P1 may be connected to the scan line Xs, whereas a first terminal (drain D) of the programming transistor P1 may be connected to the data line Yd. A second terminal (source S) of the programming transistor P1 may be connected to a first terminal (drain D) of the driving transistor P2.

The memory capacitor Cm may store image data for each pixel. The memory capacitor Cm may be connected between a gate and a second terminal (source S) of the driving transistor P2 in parallel. For example, a first terminal of the memory capacitor Cm may be connected to the gate of the driving transistor P2, and a second terminal may be connected to the second terminal (source S) of the driving transistor P2. An anode of an OLED may also be connected to the first terminal (drain D) of the driving transistor P2. A cathode K of the OLED may correspond to a common electrode shared by the entire display.

A gate of the switching transistor P3 may be connected to the scan line Xs and to the gate of the programming transistor P1. A second terminal (drain D) of the switching transistor P3 may be connected to the second terminal (source S) of the programming transistor P1 and the first terminal (drain D) of the driving transistor P2. A first terminal (source S) of the switching transistor P3 may be connected to a node at which the gate of the driving transistor P2 and the first terminal of the memory capacitor Cm are connected. The transistors P1, P2, and P3 may be organic transistors.

FIG. 7 is an equivalent circuit diagram of an example embodiment of a unit pixel of the AMOLED display of FIG. 6.

Referring to FIG. 7, a gate of the programming transistor P1 may be connected to the scan line Xs. A vertical scan signal may be applied to the gate of the programming transistor P1 via the scan line Xs. The first terminal (drain D) of the programming transistor P1 may be connected to the data line Yd. The data current signal may be applied to the first terminal (drain D) of the programming transistor P1 via the data line Yd. A gate of the switching transistor P3 may be connected to the scan line Xs and to the gate of the programming transistor P1.

The first terminal (source S) of the switching transistor P3 may be connected to the gate of the driving transistor P2 and a first terminal of the memory capacitor Cm. The second terminal (drain D) of the switching transistor P3 may be connected to the first terminal (drain D) of the driving transistor P2. An anode of the OLED and the second terminal (source S) of the programming transistor P1 may also be connected to the first terminal (drain D) of the driving transistor P2. A first terminal of the memory capacitor Cm may be connected to the gate of the driving transistor P2, whereas a second terminal of the memory capacitor Cm may be connected to the second terminal (source S) of the driving transistor P2. A supply voltage Vss may be applied to the second terminal (source S) of the driving transistor P2 via the power line Zd.

A current controller (a current driving integrated circuit (IC)) as described above may be connected to the data line Yd. The current controller determines a current flowing through the driving transistor P2 irrespective (or independent) of a threshold voltage of the driving transistor P2 to store a voltage corresponding to the current in the memory capacitor Cm.

Example operation of the unit pixel of FIG. 7 will now be described.

A unit pixel circuit of the AMOLED display according to an example embodiment may be of a current programmed type having a 3 transistor-1 capacitor (3T-1C) structure including three P-channel transistors P1, P2, and P3 and a memory capacitor Cm.

The amount of a current flowing in the OLED may be controlled by the driving transistor P2. For example, the amount of a current flowing in the driving transistor P2 may be controlled by a voltage formed at a gate node of the driving transistor P2. A voltage corresponding to a current flowing between the first terminal (drain D) and the second terminal (source S) of the driving transistor P2 may be stored and maintained in the memory capacitor Cm for a frame. A voltage at the both terminals of the memory capacitor Cm may be automatically generated by a current flowing through the driving transistor P2.

In one example, when the driving voltage is turned on, a driving voltage may be applied to the second terminal (source S) of the driving transistor P2 from the power line Zd, and a current, which is to flow in the OLED by the current controller connected to the data line Yd, may flow through the driving transistor P2. If a given current flows through the driving transistor P2 due to the current controller, a voltage corresponding to the current may be automatically induced at each terminal of the memory capacitor Cm. In this example, the programming and switching transistors P1 and P3 may turn on in response to a scan signal. Accordingly, a constant or substantially constant current may flow in the OLED regardless of a characteristic difference caused by the position and the process of a thin film transistor array. Thus, more uniform brightness may be achieved.

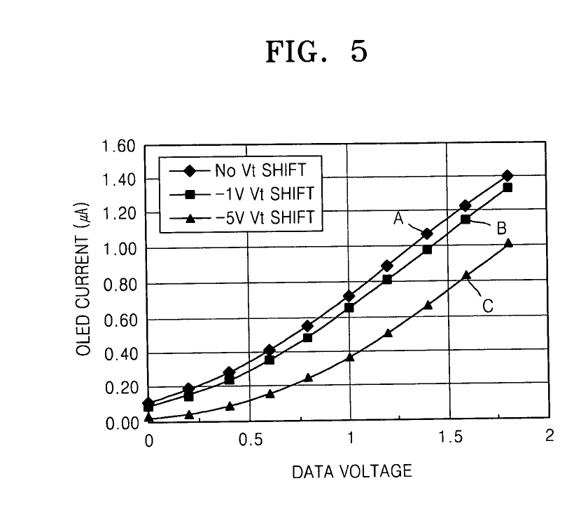

The above-described processes will now be described in phases with reference to FIGS. 8A and 8B.

Initially, the programming and switching transistors P1 and P3 may be turned off and the driving transistor P2 provides a current to the OLED from a previous frame. A voltage applied to the source node of the driving transistor P2 may switch from the level of a voltage Vss to the level of a lower voltage Vn. Lower voltage Vn may be a voltage low enough to turn off the OLED.

A current programming step may be performed by applying a corresponding signal through the scan line so as to turn on the programming transistor P1 and the switching transistor P3. Accordingly, a programming current Idata flows through the first terminal (drain D) and the second terminal (source S) of the driving transistor P2 and the first terminal (drain D) and the second terminal (source S) of the programming transistor P1. In this example, the amount of the programming current Idata may be determined by the current controller as described above. As a result, a voltage Vd corresponding to the current may be induced at the gate and the second terminal (source S) of the driving transistor P2, and each terminal of the memory capacitor Cm as shown in FIG. 8A.

After the corresponding signal applied through the scan line Xs is blocked to turn off the programming transistor P1 and the switching transistor P3, a driving voltage Vss necessary for the operation of the OLED may be applied to the second terminal (source S) of the driving transistor P2. In this example, a current supplied to the OLED may be controlled according to the voltage stored in the memory capacitor Cm. This voltage may be induced so as to correspond to a current necessary for the OLED in a programming process. As a result, a desired amount of current may be supplied to the OLED as shown in FIG. 8B.

If methods according to at least this example embodiment are used, a difference between threshold voltages of the driving transistors may be overcome. Also, more uniform programming currents Idata may be supplied to the OLEDs of all pixels. Thus, pixels showing more uniform brightness on the entire display may be realized.

FIGS. 9 and 10 graphs illustrating results of simulations performed on the performance of an example embodiment of a unit pixel of the AMOLED display of FIG. 6. The transistor parameters for P1, P2, and P3 are based on typical parameters for pentacene-based organic field-effect transistors, and the OLED parameters are based on typical OLED devices. FIG. 9 illustrates an example relationship between a data voltage and an OLED current. FIG. 10 illustrates an example relationship between a data current and the OLED current.

In FIGS. 9 and 10, “A” indicates a threshold voltage, which has not shifted, “B” indicates a threshold voltage which has been shifted by −1 V, and “C” indicates a threshold voltage which has been shifted by −5 V.

According to the results of the simulations, an error of about 58% occurs in the shift of the threshold voltage of −5 V in the conventional method; whereas an error of only 22% occurs accordance with the example embodiment shown in FIG. 6, for example.

Example embodiments may be applied to display devices, such as, AMOLED displays using OLEDs. The AMOLED display may use p-channel field-effect transistors made from, for example, polysilicon or an organic semiconductor such as pentacene as active elements.

As described above, in AMOLED displays according to example embodiments, a current programming method providing a more uniform current may be adopted. Thus, a more uniform current may be supplied to OLEDs of all or substantially all pixels regardless of a difference between the threshold voltages of driving transistors. Thus, an image having more uniform brightness may be realized. According to the experimental results, a current may be more precisely controlled with respect to a shift of a threshold voltage Vth of a driving transistor than in conventional methods. Such a current programmed display according to example embodiments may have a simpler structure than conventional current programmed self-compensating pixel circuits.

While the present invention has been particularly shown and described with reference to example embodiments thereof, it will be understood by those of ordinary skill in the art that various changes in form and details may be made therein without departing from the spirit and scope of the present invention as defined by the following claims.

What is claimed is:

1. A unit pixel of an organic light emitting diode display, the unit pixel comprising:
an organic light emitting diode;
a driving transistor including,
a first terminal connected to the organic light emitting diode, and
a second terminal supplied with a driving voltage for the operation of the organic light emitting diode;
a memory capacitor connected in parallel between a gate of the driving transistor and one of the first and second terminals of the driving transistor;
a programming transistor including,
a gate configured to receive scan signals,
a first terminal configured to receive data current signals, and
a second terminal connected to the first terminal of the driving transistor; and
a switching transistor including,
a first terminal connected to the gate of the driving transistor,
a gate connected to the gate of the programming transistor, and
a second terminal connected to one of a direct current (DC) bias voltage and the second terminal of the programming transistor.

2. The unit pixel of claim 1, wherein
the first terminal of the driving transistor is a source and the second terminal of the driving transistor is a drain,
the first terminal of the programming transistor is a source, and the second terminal of the programming transistor is a drain, and
the first terminal of the switching transistor is a source, and the second terminal of the switching transistor is a drain, the drain of the switching transistor being supplied with the direct current bias voltage.

3. The unit pixel of claim 2, wherein the driving, switching, and programming transistors are N-channel transistors.

4. The unit pixel of claim 2, wherein the driving, switching, and programming transistors are amorphous silicon transistors.

5. The unit pixel of claim 4, wherein the bias voltage is a positive voltage less than the driving voltage.

6. The unit pixel of claim 2, wherein the bias voltage is a positive voltage less than the driving voltage.

7. An active matrix organic light emitting diode (AMOLED) display comprising:
a plurality of scan lines and a plurality of data lines arranged in a matrix, the plurality of scan and data lines defining a plurality of pixel areas;
a unit pixel of claim 2 provided in each of the pixel areas; and
a current controller configured to determine a current flowing through the driving transistor and the programming transistor in each of the unit pixels.

8. The AMOLED display of claim 7, wherein the driving, switching, and programming transistors are N-channel transistors.

9. The AMOLED display of claim 7, wherein the driving, switching, and programming transistors are amorphous silicon transistors.

10. The AMOLED display of claim 9, wherein the bias voltage is a positive voltage less than the driving voltage.

11. The AMOLED display of claim 7, wherein the bias voltage is a positive voltage less than the driving voltage.

12. The unit pixel of claim 1, wherein
the first terminal of the driving transistor is a drain and the second terminal of the driving transistor is a source,
the first terminal of the programming transistor is a drain and the second terminal of the programming transistor is a source, and
the first terminal of the switching transistor is a source, and the second terminal of the switching transistor is a drain, the drain of the switching transistor being connected to the source of the programming transistor.

13. The unit pixel of claim 12, wherein the driving, switching, and programming transistors are p-channel transistors.

14. The unit pixel of claim 12, wherein the driving, switching, and programming transistors are organic transistors.

15. An active matrix organic light emitting diode (AMOLED) display comprising:
a plurality of scan lines and a plurality of data lines arranged in a matrix, the plurality of scan and data lines defining a plurality of pixel areas;
a unit pixel of claim 12 provided in each of the pixel areas; and
a current controller configured to determine a current flowing through the driving transistor and the switching transistor in each of the unit pixels.

16. The AMOLED display of claim 15, wherein the driving, switching, and programming transistors include p-channel transistors.

17. The AMOLED display of claim 15, wherein the driving, switching, and programming transistors are organic transistors.

18. An active matrix organic light emitting diode (AMOLED) display comprising:
a plurality of scan lines and a plurality of data lines arranged in a matrix, the plurality of scan and data lines defining a plurality of pixel areas;
a unit pixel of claim 1 provided in each of the pixel areas; and
a current controller configured to determine a current flowing through the driving transistor and the switching transistor in each of the unit pixels.

19. The AMOLED display of claim 18, wherein the second terminal of the switching transistor is connected to the DC bias voltage, but not the second terminal of the programming transistor.

20. The AMOLED display of claim 18, wherein the second terminal of the switching transistor is connected to the second terminal of the programming transistor, but not the DC bias voltage.
